(19) United States
(12) Patent Application Publication
(10) Pub. No.: US 2025/0013233 A1
(43) Pub. Date: Jan. 9, 2025

(54) COGNITIVE ROBOTIC SYSTEMS AND METHODS WITH FEAR BASED ACTION/REACTION

(71) Applicant: Intel Corporation, Santa Clara, CA (US)

(72) Inventors: Igor Tatourian, Fountain Hills, AZ (US); Hassnaa Moustafa, San Jose, CA (US); David John Zage, Fremont, CA (US)

(21) Appl. No.: 18/891,741

(22) Filed: Sep. 20, 2024

Related U.S. Application Data
(63) Continuation of application No. 16/581,628, filed on Sep. 24, 2019.

(51) Int. Cl. G05D 1/00; B25J 9/16; B60W 30/09

(52) U.S. Cl. CPC G05D 1/0214; B25J 9/163; B25J 9/1666; B60W 30/09

(57) ABSTRACT

Apparatuses, storage media and methods associated with cognitive robot systems, such as ADAS for CAD vehicles, are disclosed herein. In some embodiments, an apparatus includes emotional circuitry to receive stimuli for a robot integrally having the robotic system, process the received stimuli to identify potential adversities, and output information describing the identified potential adversities; and thinking circuitry to receive the information describing the identified potential adversities, process the received information describing the identified potential adversities to determine respective fear levels for the identified potential adversities in view of a current context of the robot, and generate commands to the robot to respond to the identified potential adversities, based at least in part on the determined fear levels for the identified potential adversities. Other embodiments are also described and claimed.

### PRIORITY APPLICATION

This application is a continuation of U.S. application Ser. No. 16/581,628, filed Sep. 24, 2019, which is incorporated herein by reference in its entirety.

### TECHNICAL FIELD

The present disclosure relates to the field of cognitive robotics. More particularly, the present disclosure relates to cognitive robotic systems and methods with integral capability (circuitry) for fear based action/reaction, having particular application to advanced driving assistance systems (ADAS) for computer-assisted driving (CAD) vehicles.

### BACKGROUND

With advances in integrated circuits, sensors, computing and related technologies, major advances have been achieved in recent years in the field of cognitive robotics. Cognitive robotics is concerned with endowing a robot with intelligent behavior by providing it with a processing architecture that will allow it to learn and reason about how to behave in response to complex goals in a complex world. Examples of cognitive robotic systems include, but are not limited to, ADAS for CAD vehicles.

Current ADAS-equipped CAD vehicles focus on advanced features assisting the driver (e.g., parking assist, lane departure warning, cruise control, and autopilot mode on highways), relieving the driver when the vehicle is in an enabled autopilot mode. These ADAS features not only provide comfort to human drivers, but may also improve crash avoidance and accident reductions through continuous warnings about road conditions (e.g., speed limits) and emerging hazards (e.g., pedestrian crossing). However, human driver distraction, undisciplined driving, and vehicle reaction to odd/unknown road hazards (e.g., heavy mud following rain, a rock in the middle of the road, or leftover objects from littering, etc.) are still major causes of crashes/accidents and there is not yet an ADAS feature to mitigate these cases.

Targeted, off-the-shelves products exist today that can be retrofitted into CAD vehicles to monitor drivers' attention and display some warnings, but their market adoption is slow and they are not an integral part of the built in ADAS systems. Additionally, human drivers may not heed such warnings, especially if they have ever been shown false alerts previously or are in a rush. For example, a human driver may willingly take the risk of running out of gas by not stopping at a gas station even though the low gas indicator is on. Finally, human drivers will not learn from these types of warnings as they come mostly in the form of blame.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an overview of a cognitive robotic system having fear based action/reaction technology of the present disclosure, in accordance with various embodiments.

FIG. 2 illustrates an example environment suitable for incorporating and using the fear based action/reaction technology of the present disclosure, in accordance with various embodiments.

FIG. 3 illustrates a component view of an example ADAS having integral circuitry to determine and respond to fear, according to various embodiments.

FIG. 4 illustrates an example implementation of the threat perception circuitry of FIG. 3, in accordance with various embodiments.

FIG. 5 illustrates an example implementation of the threat responding circuitry of FIG. 3, in accordance with various embodiments.

FIG. 6 illustrates the example fear notification of FIG. 2 in further detail, according to various embodiments.

FIG. 7 illustrates an example process for providing guidance to an ADAS on fear based actions/reactions to perceived threats, in accordance with various embodiments.

FIG. 8 illustrates a software component view of an example in-vehicle system having the fear based action/reaction technology of the present disclosure, in accordance with various embodiments.

FIG. 9 illustrates a hardware component view of an example computer platform, suitable for use as an in-vehicle system or a cloud server, in accordance with various embodiments.

FIG. 10 illustrates a storage medium having example instructions for practicing methods described with references to FIGS. 1-7, in accordance with various embodiments.

### DETAILED DESCRIPTION

Apparatuses, storage media and methods associated with cognitive robot systems, such as ADAS for CAD vehicles are disclosed herein. In particular, disclosed herein includes embodiments that add a fear indicator feature as a part of a cognitive robot system, e.g., current ADAS systems offered by original equipment manufacturers (OEMs) for CAD vehicles. This fear indicator feature mimics the human autonomic nervous system to allow learning and reacting to dangerous driving situations. It consists of:
Physical measurement that the subject cognitive robotic system does for the cognitive robot with respect to its movements, combined with the subject robot's human operator physical monitoring.
Emotional sensing by the subject robot to other robots in its surrounding that are potentially facing similar hazards consequences.
Reaction creation by the subject robot learned through undesirable consequences during operation.

In addition to the fear indicator notifying a human operator that the robot has an emotion indicating some level of fear for its safe operation, the robot mimics the autonomic nervous system by creating and fusing multiple channels of computing and sensing into some response signal. For example, a sympathetic channel will measure physical danger of collision and prepare response signal to the control system. Parasympathetic system will measure response of the control system of the robot and its operator, and will inhibit the sympathetic channel. Enteric system will measure that all components and signals look healthy and will inhibit parasympathetic channel if some part of the system is not operating as it should.

Further, in embodiments, the robot communicates this fear level information to nearby robots as a heat-map to prepare them for some safety action, for example slow-down, change direction, or even prepare passive safety mechanisms. Safety actions may vary and depend on proximity to the center of the heat map.

Still further, in embodiments, a social fear memory is created for the given situation/location and precompute resultant measures. A backend system may be employed to analyze the most success prevention mechanisms and in the future will use them in improved learning sets for similar danger situations. A robot, in the future, instead of running calculations and computing how its control systems should react, may use already precomputed strategy for a given problem. The backend system will again analyze and model the response to look for improved configurations. This allows for creation of cognitive social systems that always learn and improve.

In various embodiments, a robotic system comprises emotional circuitry and thinking circuitry, coupled with each other. The emotional circuitry is arranged to receive a plurality of stimuli for a robot integrally having the robotic system, process the received stimuli to identify one or more potential adversities, and output information describing the identified one or more potential adversities. And the thinking circuitry is arranged to receive the information describing the identified one or more potential adversities, process the received information describing the identified one or more potential adversities to determine respective fear levels for the identified one or more potential adversities in view of a current context of the robot, and generate commands to the robot to respond to the identified one or more potential adversities, based at least in part on the determined fear levels for the identified one or more potential adversities.

Further, in various embodiments, the robotic system may further comprise one or more contextual machines integrally disposed on the robot, and coupled to the thinking circuitry, to receive fear or fear based action or reaction data to a plurality of adversities associated with a plurality of other proximally located robots, process the fear or fear based action or reaction data of the plurality of adversities associated with the plurality of other proximally located robots to generate a plurality of context determining data, and output the plurality of context determining data for the thinking circuitry to identify the current context of the robot.

Additionally, the robotic system may comprise a fear communication machine, integrally disposed with the robot, and coupled with the thinking circuitry; with the thinking circuitry further arranged to further generate and output the determined fear levels for the identified one or more potential adversities for the fear communication machine; and the fear communication machine arranged to process the fear levels for the identified one or more potential adversities, and generate and output notifications of the fear levels for the identified one or more potential adversities for an operator interacting with the robot.

This technology is particularly applicable to ADAS of CAD vehicles, as well as other transportation modes, including but are not limited to busing, motorcycling, platooning, and so forth.

In various embodiments, an ADAS comprises threat perceiving circuitry, threat responding circuitry, and a fear communication machine coupled with each other. The threat perceiving circuitry is arranged to receive a plurality of stimuli associated with potential threats against safe operation of a CAD vehicle integrally having the DAS, process the received stimuli to identify the potential threats, and output information describing the identified potential threats. The threat responding circuitry is arranged to receive the information describing the identified potential threats, process the received information describing the identified potential threats to determine respective fear levels for the identified potential threats in view of a current context of the CAD vehicle, and output the determined respective fear levels for the identified potential threats. The fear communication machine is coupled with the threat responding circuitry to process the fear levels for the identified potential threats, and generate and output notifications of the fear levels for the identified potential threats for a driver of the CAD vehicle.

In various embodiments, a method for computer-assisted driving comprises perceiving, by an ADAS of a vehicle, with first circuitry of the ADAS, one or more potential threats to safe operation of the vehicle, based at least in part on a plurality of received stimuli; and responding, by the ADAS, with second circuitry of ADAS, different and coupled with the first circuitry, the perceived one or more potential threats, including determining fear levels for the perceived one or more potential threats, based at least in part on a current context of the vehicle, and generating one or more commands to maintain safe operation of the vehicle, based at least in part on the determined fear levels for the perceived one or more potential threats.

In various embodiments, at least one computer-readable medium (CRM) are provided with instructions. The instructions are arranged to cause an ADAS of a vehicle, in response to execution of the instruction by the ADAS, to: accept information sharing from first one or more other proximally located vehicles on fear determined for first one or more potential threats to safe operation of vehicles, by the one or more proximally located vehicles; learn operational experiences of second one or more other proximally located vehicles from observations of the second one or more other proximally located vehicles; and learn about environmental conditions of an area currently immediately surrounding the vehicle. The information sharing accepted, the operational experiences learned, and the environmental conditions learned are used to determine a current context for determining fear levels of perceived potential threats to safe operation of the vehicle.

In the following detailed description, these and other aspects of the fear based action/reaction technology will be further described. References will be made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “In some embodiments,” which may each refer to one or more of the same or different embodiments. Furthermore, the terms “comprising,” “including,” “having,” and the like, as used with respect to embodiments of the present disclosure, are synonymous.

As used herein, the term “module” or “engine” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

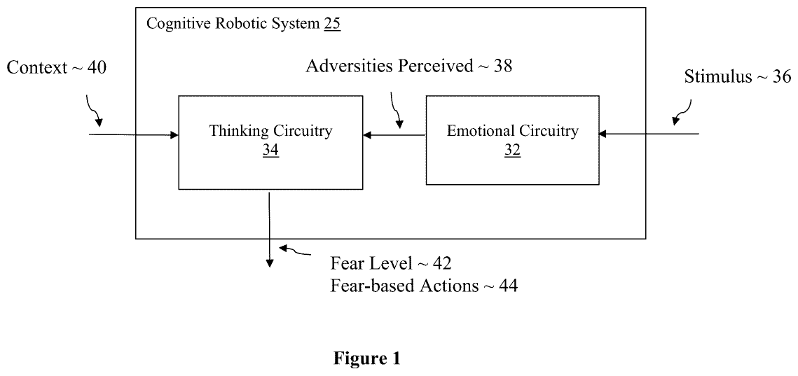

Referring now to FIG. 1, wherein an overview of a cognitive robotic system having fear based action/reaction technology of the present disclosure, in accordance with various embodiments, is illustrated. As illustrated cognitive robotic system 25, like the human brain, includes emotional circuitry 32 and thinking circuitry 34 coupled with each other. Like the part of the human brain that triggers emotions in response to stimuli, emotional circuitry 32 is arranged to receive a plurality of stimuli 36 for a robot integrally having robotic system 25, process received stimuli 36 to identify one or more potential adversities 38, and output information describing the identified one or more potential adversities 38 for thinking circuitry 34.

A potential adversity without context cannot be correctly reasoned about (e.g., a lion in the wild is a much greater potential adversity than seeing a lion in the zoo). Another part of the human brain performs the adversity interpretation and processes context to identify the necessary level of fear. Ultimately, the result of the reasoning by that part of the brain triggers the appropriate reaction based on the fear level identified. Fear reaction starts in the brain and spreads through the body to make adjustment for the best defense. Upon identified fear, the human brain causes bodily changes (e.g., heart rate and blood pressure rise, blood flow to skeletal muscles increases) to prepare the human being to be more efficient in dealing with the adversity.

Similarly, thinking circuitry 34 is arranged to receive the information describing the identified one or more potential adversities 38, process the received information describing the identified one or more potential adversities 38 to determine respective fear levels 42 for the identified one or more potential adversities in view of a current context 40 of the robot. Additionally, for the illustrated embodiments, thinking circuitry 34 is further arranged to generate commands to the robot to respond to the identified one or more potential adversities 38, based at least in part on the determined fear levels 42 for the identified one or more potential adversities 38, i.e. fear based actions 44.

Besides threat stimulus, observation and social learning influence the way the human determines the context, and experiences fear, building the sense of control in reaction to fear.
Reaction to fear is not binary based on threat stimulus, but contextual reasoning helps identifying the reaction.
Reaction to fear is often built through learning, where the human learns fear through personal experience or observing other humans' personal experience (e.g., burning his or her hand on a hot stove or observing someone else touch a hot stove).
Evolutionary way of learning in humans is through instruction, where human learns from spoken words or written notes (e.g., a red caution sign next to the stove burner will trigger a fear response).
Human brain can be positively influenced and socially learn from the emotion of others (e.g., if a human brain sees a person next to him or her experiencing a situation that appears fearful but the person is laughing, then the human brain will pick up on this positive emotion state).

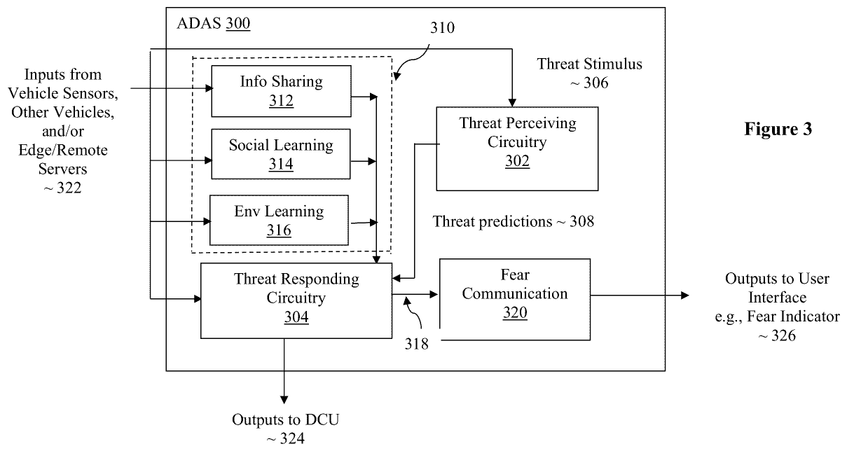

Thus, in various embodiments, various contextual machines (not shown in FIG. 1, see e.g., 310 of FIG. 3) may additionally be provided, integrally disposed on the robot, and coupled to the thinking circuitry. The contextual machines may be arranged to receive fear or fear based action/reaction data for a plurality of adversities associated with a plurality other proximally located robots, process the fear or fear based action/reaction data for the plurality of adversities associated with a plurality other proximally located robots to generate a plurality of context determining data, and output the context determining data for thinking circuitry to identify or assist in the identification of the current context of the robot, and output information describing the current context of the robot for the thinking circuitry 34.

Further, in various embodiments, robotic system 25 may additionally be provided with a fear communication machine (not shown in FIG. 1, see e.g., 320 of FIG. 3), integrally disposed with the robot, and coupled with the thinking circuitry. For these embodiments, thinking circuitry 34 is further arranged to further generate and output determined fear levels 42 for identified one or more potential adversities 38 for the fear communication machine. The fear communication machine may be arranged to process fear levels 42 for identified one or more potential adversities 38 and generates and outputs notifications of the fear levels for potential adversities 38 for an operator interacting with the robot.

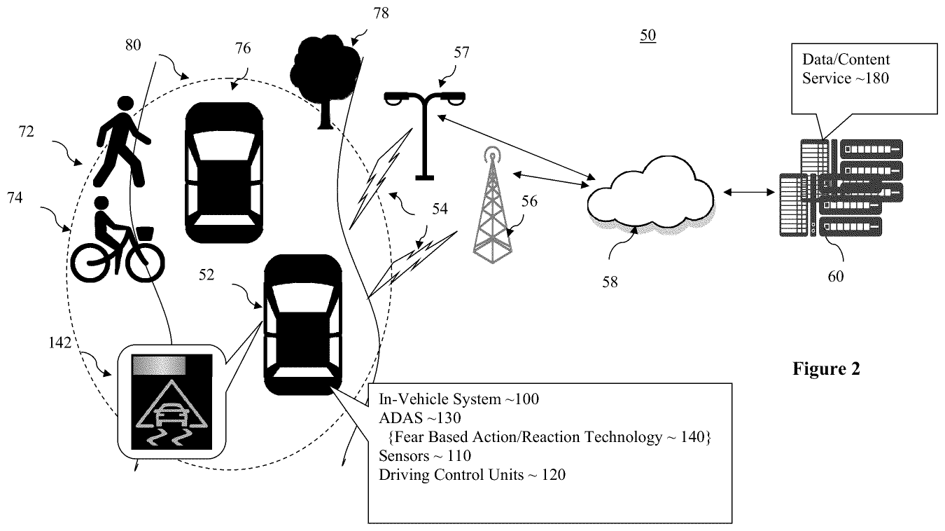

These and other aspects of the fear based action/reaction technology will be further described below with an example application to ADAS of CAD vehicles, referencing FIGS. 2-10. The example description is not to be construed as limiting on the present disclosure. As noted, the fear based action/reaction technology disclosed herein applies to other transportation modes, such as busing, motorcycling, platooning, and so forth, and in general, to cognitive robot systems.

Referring now to FIG. 2, wherein an overview of an example environment for incorporating and using the fear based action/reaction technology of the present disclosure, in accordance with various embodiments, is illustrated. As shown, for the illustrated embodiments, example environment 50 includes moving vehicle 52 having ADAS 130 incorporated with the fear based action/reaction technology 140 of the present disclosure, en route to a destination. As vehicle 52 drives on a roadway, which may be an alley, a street, a boulevard, or a highway, the roadway may be straight or curvy. The road surface condition may be dry and good, or slippery, i.e., wet or icy due to current or recent past precipitations, rainfall or snow. The visibility may be good or poor due to heavy precipitation or fog. Additionally, in its surrounding area 80, there may be other vehicles, e.g., vehicle 76, pedestrian 72, bicyclist 74, objects, such as tree 78, lamp post 57, or road signs (not shown).

Vehicle 52 may be operated manually by a human driver with computer assistance, or a fully autonomous vehicle. Due to poor driving conditions and/or inattentive/inappropriate operation by the driver, e.g., the driver is sleepy, tired, speeding and so forth, vehicle 52 may be operated into a potential emergency situation, i.e., a serious, unexpected, and often dangerous situation, requiring immediate action. Examples of such emergency situations may include, but are not limited to, slipping off the roadway, and/or hitting a nearby vehicle, a pedestrian, a bicyclist, a tree, a road sign, and so forth. ADAS 130, with the incorporated fear based action/reaction technology of the present disclosure, is arranged to perceive the impending potential emergency situation, determine a fear level for the potential emergency situation based at least in part of the context of vehicle 52, and automatically generates remedial actions/reactions, based at least in part on the determined fear level, to prevent vehicle 52 from being operated into the potential emergency situation. In various embodiments, ADAS 130 may further generate notifications for the fear based actions/reactions to the potential emergency situation, for a driver of vehicle 52. ADAS 130 hereafter may also be simply referred to as driving assistance systems (DAS).

In various embodiments, vehicle 52 further include sensors 110 and driving control units 120 (DCUs). ADAS 130, with fear based action/reaction technology, is arranged to perceive whether vehicle 52 is about to be operated into a potential emergency situation based at least in part on sensor data provided by sensors 110 of vehicle 52 (e.g., sensor data associated with the determination of vehicle motion dynamics and traction with the road). Additionally, ADAS 130 is arranged to determine a context of vehicle 52 to interpret and respond to the perceived potential emergency situation, based at least in part on fear and/or fear based actions/reactions to various threats of nearby vehicles 76, and/or environmental condition data provided by remote server(s) 60, nearby vehicles (e.g., vehicle 76), roadside units (e.g., base station/cell tower 56, access point/edge server on lamppost 57 and so forth), and/or personal systems worn by pedestrian 72/bicyclist 74. ADAS 130 analyzes these data to determine the context to interpret and respond to the potential emergency situation perceived.

In various embodiments, ADAS 130 may perform the threat perception, fear determination and fear based responses, ignoring other vehicles and objects on the road. Further, the computation may be done independently, and in parallel to other ADAS functions. In various embodiments, the potential adversity/emergency and fear perceived, as well as fear based actions/reactions taken, may be communicated to the driver via the cluster dashboard of vehicle 52.

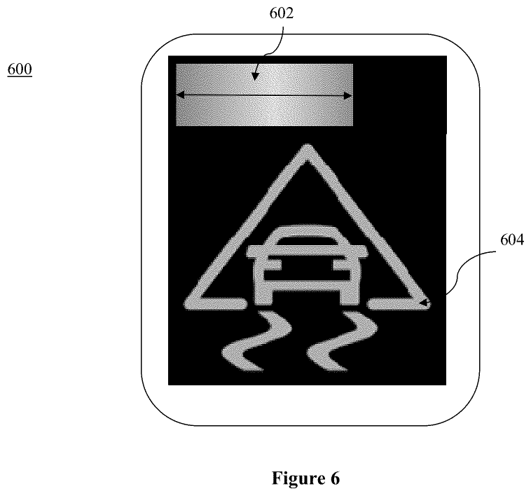

In various embodiments, ADAS 130 is further arranged to provide audio, visual and/or mechanical alerts to the driver, informing the driver of vehicle 52 of the adversity and/or fear perceived, as well as the fear based actions/reactions taken. Examples of audio alerts may include, but are not limited to, a sharp or loud beeping tone or an audio warning message. The volume of the tone may be proportional to the imminence of the adversity/emergency and/or fear as perceived/interpreted by ADAS 130. Examples of visual alerts may include but are not limited to any visual displays and/or messages. Similarly, the visual alerts may also convey the degree of imminence of the adversity/emergency and/or fear as perceived/interpreted by ADAS 130. In various embodiments, visual alerts include in particular, fear indicator 142, to be further described later with reference to FIG. 6. Examples of mechanical alerts may include, but are not limited to, vibration of the steering wheel, vibration of the driver seat, and so forth. Likewise, the amount of vibrations may be reflective of the degree of imminence of the adversity/emergency and/or fear as perceived/interpreted by ADAS 130.

In various embodiments, in addition to ADAS 130, vehicle 52 includes an engine, transmission, axles, wheels and so forth (not shown). Further, for the illustrated embodiments, vehicle 52 includes in-vehicle system (IVS) 100, sensors 110, and driving control units (DCUs) 120. ADAS 130 may be arranged to generate and output the fear based actions to address the adversity/emergency perceived/interpreted to DCUs 120. Additionally, IVS 100 may include navigation subsystem (not shown) configured to provide navigation guidance. ADAS 130 is configured with computer vision to recognize stationary or moving objects (such as tree 78, moving vehicle 76, bicyclist 74 and pedestrian 72) in surrounding area 80. In various embodiments, ADAS 130 is configured to recognize these stationary or moving objects in area 80 surrounding CA/AD vehicle 52, and in response, make its decision in controlling DCUs 120 of vehicle 52.

Sensors 110 include in particular one or more cameras (not shown) to capture images of surrounding area 80 of vehicle 52. In various embodiments, sensors 110 may also include other sensors, such as light detection and ranging (LiDAR) sensors, accelerometers, inertial units, gyroscopes, global positioning system (GPS) circuitry, pressure sensors, and so forth. These other sensors may collect a wide range sensor data about vehicle 52, including but are not limited to inertial data of the vehicle, amount of frictions at the corresponding points where tires of the vehicle contact the road surface, weight distribution of the vehicle, and so forth. Examples of driving control units (DCUs) 120 may include control units for controlling engine, transmission, brakes of CA/AD vehicle 52. In various embodiments, IVS 100 may further include a number of infotainment subsystems/applications, e.g., instrument cluster subsystem/applications, front-seat infotainment subsystem/application, such as a navigation subsystem/application, a media subsystem/application, a vehicle status subsystem/application and so forth, and a number of rear seat entertainment subsystems/applications (not shown).

In various embodiments, IVS 100 and ADAS 130, on their own or in response to user interactions, communicate or interact 54 with one or more remote/cloud servers 60, nearby vehicles, e.g., vehicle 76, and/or nearby personal systems, e.g., personal systems worn by pedestrian 72/bicyclist 74. In particular, in various embodiments, remote/cloud servers 60 include data/content services 180. Examples of data/content provided by data/content service 180 may include, but are not limited, road and/or weather conditions of various roadways at various points in time. Additional examples of data/content provided by data/content service 180 may include learned appropriate fear and/or fear based actions/reactions in response to various adversities/emergencies perceived under various contexts. The data/content may be gathered by service 180 and/or received from various third parties, e.g., reported by other vehicles 76 traveling through various road segments under various weather conditions. Service 180 may compile, aggregate, condense, summarize, the gathered/received data, as well as extrapolate and/or provide projections based on the gathered/received data. Similarly, IVS 100 and/or ADAS 130 may receive data/contents, in particular, weather/environmental data, from systems on nearby vehicle 76 and/or personal systems worn by pedestrian 72/bicyclist 74.

In various embodiments, IVS 100 and ADAS 130 may communicate 54 with server 60 via cellular communication, e.g., via a wireless signal repeater or base station on transmission tower 56 near vehicle 52, and one or more private and/or public wired and/or wireless networks 58. Examples of private and/or public wired and/or wireless networks 58 may include the Internet, the network of a cellular service provider, and so forth. It is to be understood that surrounding area 80 and transmission tower 56 may be different areas and towers at different times/locations, as vehicle 52 travels en route to its destination. In various embodiments, ADAS 130 may be equipped to communicate with other vehicles 76 and/or personal systems worn by pedestrian 72/bicyclist 74 directly via WiFi or dedicated short range communication (DSRC) in accordance with selected inter-vehicle or near field communication protocols.

Except for the fear based action/reaction technology of the present disclosure provided, ADAS 130, IVS 100 and vehicle 52 otherwise may be any one of a number of ADAS, IVS and CAD vehicles known in the art. Before further describing the fear based action/reaction technology and related aspects of ADAS 130, it should be noted that, while for case of understanding, only one other vehicle 76, one object tree 78, one pedestrian 72 and one bicyclist 74 are illustrated, the present disclosure is not so limited. In practice, there may be multitude of other vehicles 76, objects 78, pedestrians 72 and bicyclists 74 in surrounding area 80. Further, the shape and size of surrounding area 80 considered may vary from implementation to implementation.

Referring now to FIG. 3, wherein a component view of an example ADAS having integral circuitry to determine and respond to fear for various perceived threats, according to various embodiments, is illustrated. As shown, for the illustrated embodiments, ADAS 300, which may be ADAS 130 of FIG. 2, includes threat perceiving circuitry 302, threat responding circuitry 304, a number of contextual machines 310, and fear communication unit 320, coupled with each other. Contextual machines 310 includes information sharing machine 312, social learning machine 314, and environment learning machine 316.

Threat perceiving circuitry 302 is arranged to receive threat stimulus 306 and perceive/predict potential threats 308, based on stimulus 306. Threat stimulus 306 may be sensor data 322 received from various sensors of the host vehicles of ADAS 300. Examples of receipt of threat stimulus 306 and perceive/predict potential threats 308 may include, but are not limited to:
Receipt of physical measurements of the Motion Vector “MV” of the vehicle and the Inertial Vector “IV” of the vehicle (e.g., from vehicle sensors), and determining vehicle drifts based at least in part on the MV and IV measurements.
Receipt of the current vehicle speed (e.g., from vehicle sensors), and determining over-speed or under-speed with respect to the speed limit of the current road.
Receipt of measurements of longitudinal and lateral distance from surroundings (e.g., from vehicle sensors), and determining whether unsafe distances from other vehicles or objects are being maintained.
Receipt of object recognition data (e.g., from computer vision circuitry of the vehicle), and determining whether road hazards/blockers are popping up on the way (e.g., big rock, steep curvy hill, very dark area, dense fog, etc.).
Receipt of driver monitoring data (e.g., from internal cameras and sensors), and determine whether the driver is distracted.

Threat responding circuitry 304 is arranged to receive threat perceptions/predictions 308 from threat perceiving circuitry 302, and determine respective fear levels for the perceived/predicted threats 308, based at least in part on a current context of the host vehicle of ADAS 300. Additionally, threat responding circuitry 304 is arranged to output the determined fear levels 318 for fear communication machine 320, and generate various commands 324 for fear based actions/reactions to the DCUs of the host vehicle of ADAS 300. Examples of receiving threat perceptions/predictions 308 and determining fear levels and fear based actions may include, but are not limited to:
Determine fear level for a perceived obstacle (such as a big rock), and fear based action, such as driving over or around the obstacle, depending on the ability/capability of the vehicle to resist the threat stimulus (e.g., a 4×4 vehicle can pass over a big rock, but may be more unstable on tight turns).
Determine fear level for a perceived drift, and fear based action, such as corrective action, depending on whether the MV and/or IV drift are recurrent or a singular event, whether the safe distance gap is small or large, and/or whether the human-driver is completely distracted, and so forth)

In various embodiments, threat responding circuitry 304 is arranged to determine the current context of the host vehicle of ADAS 300 based at least in part on context determining data received from information sharing machine 312, social learning machine 314 and/or environment learning machine 316.

In various embodiments, information sharing machine 312 is arranged to allow other proximally located vehicles to assist the host vehicle of ADAS 300 by sharing the pain/fear the other vehicles experienced. Examples of pain/fear experienced by the other proximally located vehicles may include, but are not limited to the weather condition impact, awareness of road hazards, and awareness of a speed bump or steep hill undesirable effect. In various embodiments, informational sharing machine 312 is arranged to receive explicit messaging from other proximally located vehicles detailing situations that raised the other vehicles' fear. The explicit messages may be received wirelessly via near field wireless communication, WiFi, and so forth. In various embodiments, informational sharing machine 312 may be arranged to receive such information through other communication means, e.g., being arranged to comprehend briefly flashing of lights by the other proximally located vehicles to mean slippage and fear experienced by other proximately located vehicles. Further, informational sharing machine 312 may be arranged to differentiate different threat/fear levels by combining other signals, and/or via signal variations, such as different colors, intensity, and/or patterns.

In various embodiments, social learning machine 314 is arranged to learn about the pain/fear experience of other proximately located vehicles through observations of the behaviors of the other proximally located vehicles. For example, when the host vehicle of ADAS 300 observes another vehicle slip (from computer vision data of the host vehicle) while taking a turn, it will include the slippery condition as part of the current context in determining a fear based action to address a perceived/predicted threat, e.g., potential collision with a bicyclist. In addition, in various embodiments, social fear memory may have been created from analysis by a backend system (e.g., server 60 of FIG. 2) for the most success prevention mechanisms and made available for use by threat responding circuitry 304 (via social learning machine 314) in determining fear based actions to address similar threat/fear.

Environment learning machine 316 is arranged to allow ADAS 300 to learn about the environmental condition of the immediate surrounding of the host vehicle of ADAS 300, from the errors of other surrounding vehicles, and make available these environmental conditions learned to threat responding circuitry 304 in determining the current context. For example, observing another vehicle being stuck in a flooded road segment may enable threat responding circuitry 304 to factor the flooded condition of the road segment into the current context in deciding the fear level and fear based actions for a perceived/predicted threat. Similarly, observing another vehicle crashed in a foggy condition may enable the threat responding circuitry 304 to factor the foggy condition into the current context in deciding the fear level and fear based actions for a perceived/predicted threat. This is similar to a human who avoids getting hurt when he/she sees others getting hurt from an environmental situation.

In various embodiments, the fear based actions/reactions may take several forms that can include, but are not limited to:
Slowing down the vehicle on steep hill
Bypassing a big rock on the road
Change route to avoid a flooded road segment
Stimulate the human-driver to pay extra attention.

In various embodiments, as part of the fear based action/reaction, any reasoning that causes a fear action/reaction may be relayed to the human driver to inform the human driver of the current state of the host vehicle of ADAS 300. Not only does this ensure the driver is aware of the actions taken by ADAS 300 on their behalf, the driver can use it as a learning aid for better driving.

In various embodiments, each of threat perceiving circuitry 302, threat responding circuitry 304, contextual machines 310, and fear communication unit 320 may be implemented in hardware or software, or combination thereof. Examples of hardware implementations may include ASIC or programmable circuits (such as Field Programmable Gate Arrays). Example of software implementations may include programs in any one of a number of programming languages supported or compiled into machine language supported by a hardware processor. Additionally, threat responding circuitry 304 may be referred to as threat interpreting circuitry.

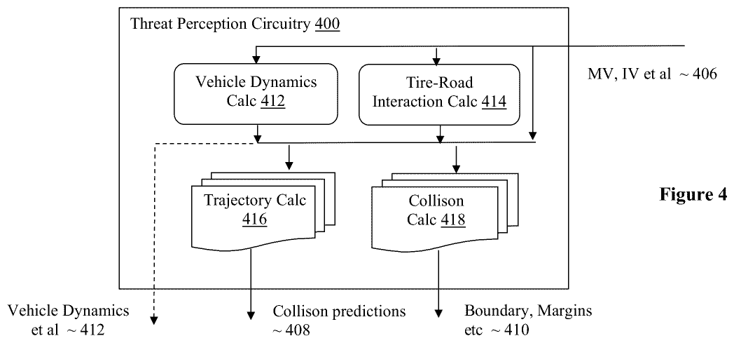

Referring now to FIG. 4, wherein an example implementation of the threat perception circuitry of FIG. 3, in accordance with various embodiments, is illustrated. As shown, for the illustrated embodiments, example threat perception circuitry 400, which may be threat perceiving circuitry 302 of FIG. 3, includes vehicle dynamics calculator 412, tire-road interaction calculator 414, trajectory calculators 416 and collision calculators 418, coupled with each other.

Vehicle dynamics calculator 412 is arranged to calculate a kinematic model for the motion of the vehicle, based at least in part of the IV and MV data received. Tire-road interaction calculator 414 is arranged to calculate the vehicle's yaw rate, the vehicle's sideslip angle and road friction, based at least in part on various sensor data received. For examples, yaw rate can be calculated based at least in part on sensor data provided by inertial and/or motion sensors of the vehicle. The sideslip angle can be calculated based at least in part on data provided by Global Positioning System (GPS), inertial and/or optical sensors. Road friction coefficient can be calculated based at least in part on sensor data provided by optical sensor on light absorption and/or scattering characteristics of the road indicative of water, ice or other fluidic substance on the road surface.

Trajectory calculators 416 are arranged to identify all dynamic objects within a risk zone, and computes whether their paths may intersect the path of the vehicle in space and time. The path of the vehicle is calculated based at least in part on the results of the calculations of vehicle dynamics calculator 412 and tire-road interaction calculator 414. In various embodiments, the calculations of whether all dynamic objects within the risk zone may intersect the path of the vehicle in space and time may be computed in parallel, and/or using multiple models. When multiple models are used, the calculation results of the various models may be weighted to arrive at a consensus.

Collision calculator 418 is arranged to calculate the safety boundary and/or margins, based at least in part on sensor data received indicative of road boundaries, and/or objects on or off the road. In various embodiments, different artificial intelligence models, such as Markov or Stochastic processes, are used. Similarly, when multiple models are used, the calculation results of the various models may be weighted to arrive at a consensus.

In various embodiments, in addition to collision predictions 408, boundaries and margins 410, various results of vehicle dynamics and tire-road interaction calculation results 412 may also be outputted by threat perception circuitry 400.

In various embodiments, each of vehicle dynamics calculator 412, tire-road interaction calculator 414, trajectory calculators 416 and collision calculators 418 may be implemented in hardware or software, or combination thereof. Examples of hardware implementations may include ASIC or programmable circuits (such as Field Programmable Gate Arrays). Example of software implementations may include programs in any one of a number of programming languages supported or compiled into machine language supported by a hardware processor (not shown).

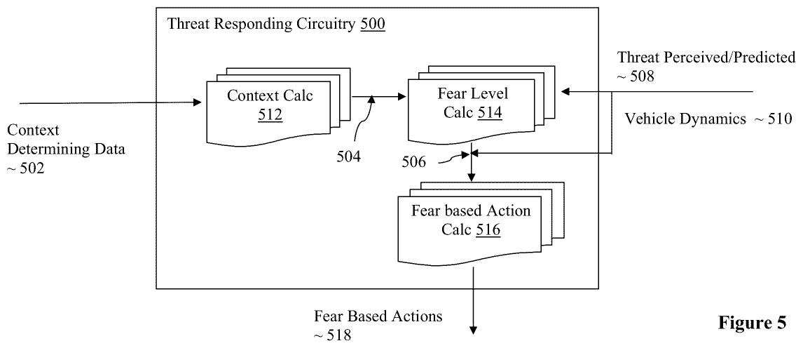

Referring now to FIG. 5, wherein an example implementation of the threat responding circuitry of FIG. 3, in accordance with various embodiments, is illustrated. As shown, threat responding circuitry 500, which may be threat responding circuitry 304 of FIG. 3, includes context calculators 512, fear level calculators 514, and fear based action calculators 516, coupled with each other.

Context calculators 512 are arranged to perform a number of calculations in parallel for a number of context models to determine a current context 504 of the host vehicle to interpret the threats perceived, based at least in part on context determining data 502 received, e.g., from contextual machines 310 of FIG. 3. Any number of context models developed through machine learning from training data may be employed. The results of the various context models may be weighted to arrive at a consensus.

Fear level calculators 514 are arranged to perform a number of calculations in parallel for a number of fear models to determine fear levels 506 for various perceived/predicted threats, based at least in part on current context 504, threat perceived/predicted 508 and optionally, vehicle dynamics and tire-road interaction data 510 received, e.g., from threat perception circuitry 400 of FIG. 4. In various embodiments, one of the models used is an adaptation of Fokker-Planck equation with the goal to quantify some assumptions (based on, e.g., one or more preloaded fear policies) of an error and to approximate propagated Probability Density Function (PDF). Similar to context calculator 512, any number of fear models developed through machine learning from training data may be employed. The results of the various fear models may be weighted to arrive at a consensus.

Fear based action calculators 516 is arranged to perform a number of calculations in parallel for a number of action models to determine fear based actions/reactions 518 to the threats perceived/predicted 508, based at least in part on threats perceived/predicted 508, fear levels determined 506 received, e.g., from threat perception circuitry 400 of FIG. 4 and fear level calculators 514, and one or more preloaded action/reaction policies. Likewise, any number of fear based action/reaction models developed through machine learning from training data may be employed. The results of the various fear based action/reaction models may be weighted to arrive at a consensus.

Referring now to FIG. 6, wherein an example visual alert for a fear level determined for an example threat perceived, according to various embodiments, is illustrated. As shown, for the illustrated embodiments, the visual alerts include a fear indictor 600 that reflects the assessment of ADAS 130 with respect to the fear level of vehicle 52 being manually operated into an emergency (slippage) situation. Fear indictor 600 includes a spectrum 602 of fear, and an indicator 604 pointing to a point on spectrum 602 to reflect the current fear level assessment of ADAS 130. In various embodiments, spectrum 602 may be colored, e.g., spanning from dark green, indicative of low level of fear, to light green then light yellow, indicative of various medium level of fear, then dark yellow to orange and red, indicative of various higher and higher levels of fear. In FIG. 6, the different colors are correspondingly depicted by different shades of gray. For the illustrated embodiments, a triangle have a sliding vehicle is used as indicator 604 to point to a location on spectrum 602 to denote the current assessment of fear of the vehicle being operated into an emergency (slippage) In alternate embodiments, other graphical elements may be used to visually convey the fear level assessment. In various embodiments, fear indicator 600 may also convey how confident ADAS 130 is, on its computation and prediction whether the vehicle can recover in case a driver loses control. In various embodiments, the computation that predicts vehicle dynamics for the next t-seconds based on vector of motion, road traction, road curvature and width, and other environmental parameters, will not only suggest that fear of slippage is high or low, but will also display recommended safe operating parameters including but are not limited to speed, lane selection, time to destination if driving as the vehicle is operated now versus driving as suggested.

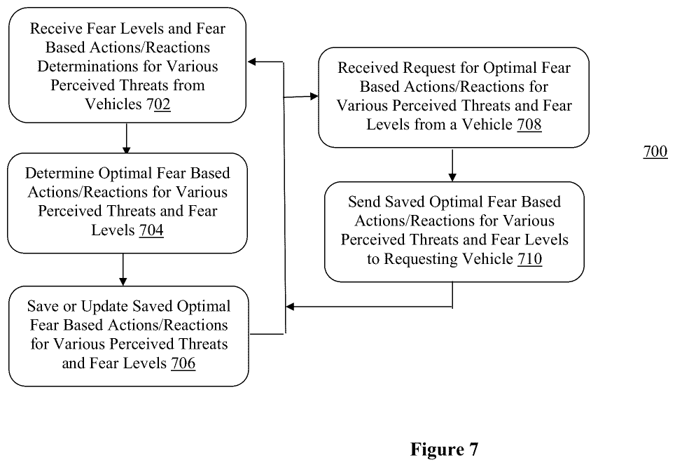

Referring now to FIG. 7, wherein an example process for providing guidance to an ADAS on fear based actions/reactions to perceived threats under various levels of fear determined, in accordance with various embodiments, is illustrated. As shown, for the illustrated embodiments, method/process 700 for providing guidance to an ADAS on fear based actions/reactions to perceived threats includes operations performed in blocks 702-710. The operations of method/process 700 may be performed by one or more servers 60 of FIG. 2.

Process 700 starts at block 702. At block 702, fear levels and fear based actions/reactions determinations for various perceived threats under various contexts are received from various vehicles. At block 704, optimal fear based actions/reactions for various fear levels for various perceived threats are determined, based at least in part on the determinations received from the various vehicles. At block 706, the determined optimal fear based actions/reactions for various fear levels for various perceived threats are saved.

From block 706, process may return to block 702 if it receives additional reporting of fear levels and fear based actions/reactions determinations for various perceived threats under various contexts from reporting vehicles, and continue there from as earlier described. From block 706, process may proceed to block 708 if it receives requests for guidance on fear based actions/reactions for various fear levels and perceived threats from a requesting vehicle.

At block 708, a request for guidance on fear based actions/reactions for one or more fear levels and perceived threats is received from a requesting vehicle. At block 710, previously determined and saved optimal fear based actions/reactions for the requested one or more fear levels for perceived threats, if they exist, are retrieved and send to the requesting vehicle.

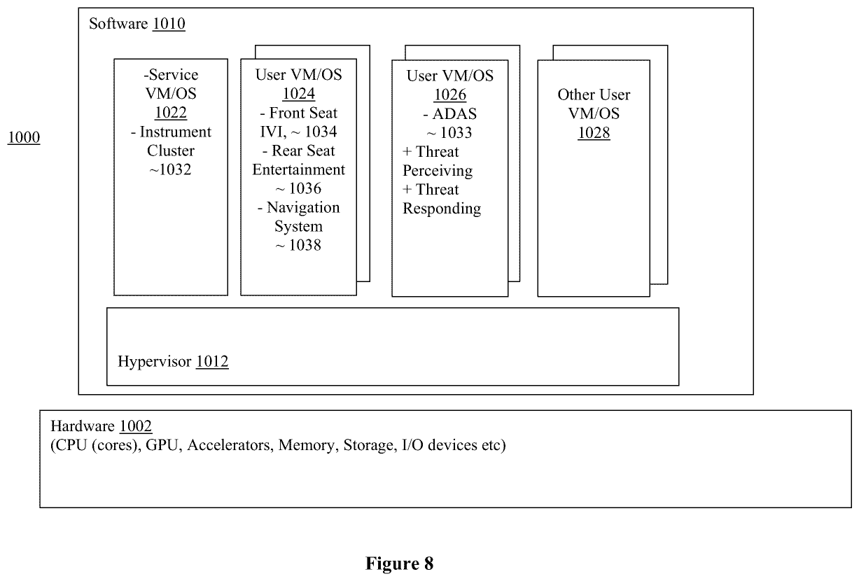

Referring now to FIG. 8, wherein a software component view of the in-vehicle system, according to various embodiments, is illustrated. As shown, for the embodiments, IVS system 1000, which could be IVS system 100, includes hardware 1002 and software 1010. Hardware 1002 includes CPU (cores), GPU, other hardware accelerators, memory, persistent storage, input/output (I/O) devices, and so forth. Software 1010 includes hypervisor 1012 hosting a number of virtual machines (VMs) 1022-1028. Hypervisor 1012 is configured to host execution of VMs 1022-1028. The VMs 1022-1028 include a service VM 1022 and a number of user VMs 1024-1028. Service machine 1022 includes a service OS hosting execution of a number of instrument cluster applications 1032. User VMs 1024-1028 may include a first number of user VMs 1024 having a first number of user operating system (OS) hosting execution of front seat infotainment applications 1034, rear seat infotainment applications 1036, and/or navigation subsystem 1038, a second number of user VMs 1026 having a second number of user OS hosting execution of an ADAS 1033, e.g., ADAS 130 of FIG. 2 or 300 of FIG. 3, incorporated with the fear based action/reaction technology of the present disclosure, and a third number of user VMs 1028 having a third number of user OS hosting execution of other applications.

Except for the fear based action/reaction technology of the present disclosure incorporated, elements 1012-1038 of software 1010 may be any one of a number of these elements known in the art. For example, hypervisor 1012 may be any one of a number of hypervisors known in the art, such as KVM, an open source hypervisor, Xen, available from Citrix Inc, of Fort Lauderdale, FL., or VMware, available from VMware Inc of Palo Alto, CA, and so forth. Similarly, service OS of service VM 1022 and user OS of user VMs 1024-1028 may be any one of a number of OS known in the art, such as Linux, available, e.g., from Red Hat Enterprise of Raleigh, NC, or Android, available from Google of Mountain View, CA.

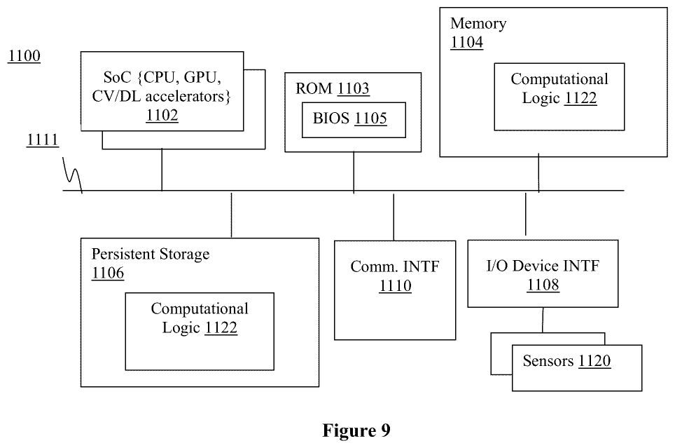

Referring now to FIG. 9, wherein an example computing platform that may be suitable for use to practice the present disclosure, according to various embodiments, is illustrated. As shown, computing platform 1100, which may be hardware 1002 of FIG. 8, or a computing platform of one of the servers 60 of FIG. 2, include one or more system-on-chips (SoCs) 1102, ROM 1103 and system memory 1104. Each SoCs 1102 may include one or more processor cores (CPUs), one or more graphics processor units (GPUs), one or more hardware accelerators, such as computer vision (CV) and/or deep learning (DL) accelerators. ROM 1103 may include basic input/output system services (BIOS) 1105. CPUs, GPUs, and CV/DL accelerators may be any one of a number of these elements known in the art. Similarly, ROM 1103 and BIOS 1105 may be any one of a number of ROM and BIOS known in the art, and system memory 1104 may be any one of a number of volatile storage devices known in the art.

Additionally, computing platform 1100 may include persistent storage devices 1106. Example of persistent storage devices 1106 may include, but are not limited to, flash drives, hard drives, compact disc read-only memory (CD-ROM) and so forth. Further, computing platform 1100 may include one or more input/output (I/O) interfaces 1108 to interface with one or more I/O devices, such as sensors 1120. Other example I/O devices may include, but are not limited to, display, keyboard, cursor control and so forth. Computing platform 1100 may also include one or more communication interfaces 1110 (such as network interface cards, modems and so forth). Communication devices may include any number of communication and I/O devices known in the art. Examples of communication devices may include, but are not limited to, networking interfaces for Bluetooth®, Near Field Communication (NFC), WiFi, Cellular communication (such as LTE 4G/5G) and so forth. The elements may be coupled to each other via system bus 1111, which may represent one or more buses. In the case of multiple buses, they may be bridged by one or more bus bridges (not shown).

Each of these elements may perform its conventional functions known in the art. In particular, ROM 1103 may include BIOS 1105 having a boot loader. System memory 1104 and mass storage devices 1106 may be employed to store a working copy and a permanent copy of the programming instructions implementing the operations associated with hypervisor 1012, service/user OS of service/user VM 1022-1028, or components of ADAS 1033, collectively referred to as computational logic 1122. The various elements may be implemented by assembler instructions supported by processor core(s) of SoCs 1102 or high-level languages, such as, for example, C, that can be compiled into such instructions. In some embodiments, some of the computing logic 1122 may be implemented in one or more hardware accelerators of SoC 1102.

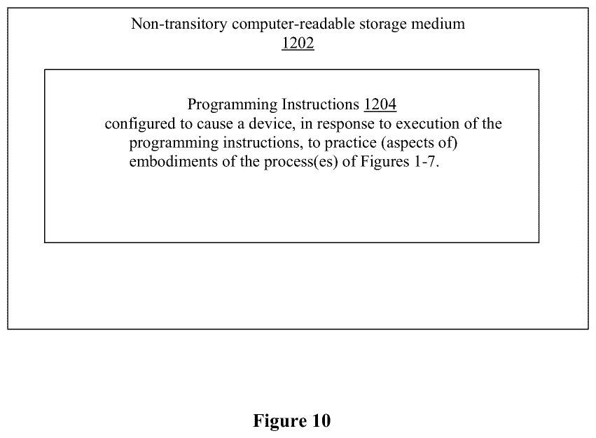

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 10 illustrates an example computer-readable non-transitory storage medium that may be suitable for use to store instructions that cause an apparatus, in response to execution of the instructions by the apparatus, to practice selected aspects of the present disclosure described with references to FIGS. 1-6. As shown, non-transitory computer-readable storage medium 1202 may include a number of programming instructions 1204. Programming instructions 1204 may be configured to enable a device, e.g., computing platform 1100, in response to execution of the programming instructions, to implement (aspects of) hypervisor 1012, service/user OS of service/user VM 1022-1028, or components of ADAS 130, 300, or 1033. In alternate embodiments, programming instructions 1204 may be disposed on multiple computer-readable non-transitory storage media 1202 instead. In still other embodiments, programming instructions 1204 may be disposed on computer-readable transitory storage media 1202, such as signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and descriptions, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Thus various example embodiments of the present disclosure have been described including, but are not limited to:

Example 1 is a robotic system, comprising: emotional circuitry to receive a plurality of stimuli for a robot integrally having the robotic system, process the received stimuli to identify one or more potential adversities, and output information describing the identified one or more potential adversities; and thinking circuitry coupled to the emotional circuitry to receive the information describing the identified one or more potential adversities, process the received information describing the identified one or more potential adversities to determine respective fear levels for the identified one or more potential adversities in view of a current context of the robot, and generate commands to the robot to respond to the identified one or more potential adversities, based at least in part on the determined fear levels for the identified one or more potential adversities.

Example 2 is example 1, further comprising one or more contextual machines integrally disposed on the robot, and coupled to the thinking circuitry, to receive fear or fear based action or reaction data for a plurality of adversities associated with a plurality of other proximally located robots, process the fear or fear based action or reaction data for the plurality of adversities associated with the plurality of other proximally located robots to generate context determining data, and output the generated context determining data for the thinking circuitry to identify the current context of the robot.

Example 3 is example 2, wherein the one or more contextual machines include an information sharing machine coupled with the thinking circuitry and arranged to receive messages from the other proximally located robots on potential adversities currently perceived and having raised fear levels determined by the other proximally located robots, pre-process the received messages into a subset of the plurality of context determining data, and output the subset of the plurality of context determining data for use by the thinking circuitry in identifying the current context of the robot.

Example 4 is example 2, wherein the one or more contextual machines include a social learning machine coupled with the thinking circuitry and arranged to receive data associated with observed behaviors of other proximally located robots, process the received data associated with observed behaviors of other proximally located robots into a subset of the plurality of context determining data, and output the subset of the plurality of context determining data for use by the thinking circuitry in identifying the current context of the robot.

Example 5 is example 2, wherein the one or more contextual machines include an environment learning machines coupled with the thinking circuitry and arranged to receive data associated with observed errors of other proximally located robots, process the received data associated with observed errors of other proximally located robots into a subset of the plurality of context determining data, and output the subset of the plurality of context determining data for use by the thinking circuitry in identifying the current context of the robot.

Example 6 is any one of examples 1-5, further comprising a fear communication machine, integrally disposed with the robot, and coupled with the thinking circuitry; wherein the thinking circuitry is arranged to further generate and output the determined fear levels for the identified one or more potential adversities for the fear communication machine; and wherein the fear communication machine is arranged to process the fear levels for the identified one or more potential adversities, and generate and output notifications of the fear levels for the identified one or more potential adversities for an operator interacting with the robot.

Example 7 is a driving assistance system (DAS), comprising: threat perceiving circuitry to receive a plurality of stimuli associated with potential threats against safe operation of a computer-assisted driving (CAD) vehicle integrally having the DAS, process the received stimuli to identify the potential threats, and output information describing the identified potential threats; threat responding circuitry coupled to the threat perceiving circuitry to receive the information describing the identified potential threats, process the received information describing the identified potential threats to determine respective fear levels for the identified potential threats in view of a current context of the CAD vehicle, and output the determined respective fear levels for the identified potential threats; and a fear communication machine coupled with the threat responding circuitry to process the fear levels for the identified potential threats, and generate and output notifications of the fear levels of the identified potential threats for a driver of the CAD vehicle.

Example 8 is example 7, wherein the plurality of stimuli include one or more of a current motion vector of the CAD vehicle, a current inertia vector of the CAD vehicle, a current speed of the CAD vehicle, a current speed limit, an amount of safe distance from another vehicle, a description of a proximally located road hazard, or state data about a driver of the CAD vehicle.

Example 9 is example 7, wherein the threat perceiving circuitry is arranged to process the plurality of stimuli to predict a likelihood of collision with another vehicle or object.

Example 10 is example 9, wherein to predict a likelihood of collision with another vehicle or object comprises to predict a likelihood of trajectory of the other vehicle or object.

Example 11 is example 7, wherein the threat perceiving circuitry is arranged to process at least a subset of the plurality of stimuli to determine lateral dynamics of the CAD vehicle or tire-road interaction of the CAD vehicle.

Example 12 is example 11, wherein to determine tire-road interaction of the CAD vehicle comprises to determine a yaw rate of the CAD vehicle, a sideslip angle of the CAD vehicle, or current road friction.

Example 13 is example 7, wherein the threat responding circuitry is further arranged to generate commands to the CAD vehicle to respond to the identified potential threats, based at least in part on the determined fear levels for the identified potential threats.

Example 14 is any one of examples 7-13, further comprising one or more contextual machines integrally disposed on the CAD vehicle, and coupled to the threat responding circuitry, to receive fear or fear based action or reaction data of a plurality of threats, associated with a plurality of other proximally located vehicles, process the fear or fear based action or reaction data of the plurality of threats associated with the plurality of other proximally located vehicles to generate a plurality of context determining data, and to output the context determining data for the thinking circuitry to identify the current context of the CAD vehicle.

Example 15 is example 14, wherein the one or more contextual machines include an information sharing machine coupled with the threat responding circuitry and arranged to receive messages from other proximally located vehicles on potential threats currently perceived and having raised fear levels determined by the other proximally located vehicles, pre-process the received messages into a subset of the plurality of context determining data, and output the subset of the plurality of context determining data for use by the threat responding circuitry in identifying the current context of the CAD vehicle.

Example 16 is example 15, wherein the messages comprise one or more messages from the other proximally located vehicles on adverse weather impact, road hazards, speed bumps, or steep terrain perceived by the other proximally located vehicles and having raised fear levels determined by the other proximally located vehicles.

Example 17 is example 14, wherein the one or more contextual machines include a social learning machine coupled with the threat responding circuitry and arranged to receive data associated with observed behaviors of other proximally located CAD vehicles, process the received data associated with observed behaviors of other proximally located vehicles into a subset of the plurality of context determining data, and output the subset of the plurality of context determining data for use by the threat responding circuitry in identifying the current context of the CAD vehicle.

Example 18 is example 17, wherein the data associated with observed behaviors of other proximally located CAD vehicles comprise data associated with observed slippage of the other proximally located CAD vehicles.

Example 19 is example 14, wherein the one or more contextual machines include an environment learning machine coupled with the threat responding circuitry and arranged to receive data associated with observed errors of other proximally located CAD vehicle, process the received data associated with observed errors of other proximally located CAD vehicle into a subset of the plurality of context determining data, and output the subset of the plurality of context determining data for use by the threat responding circuitry in identifying the current context of the CAD vehicle.

Example 20 is a method for computer-assisted driving, comprising: perceiving, by a driving assistance subsystem (DAS) of a vehicle, with first circuitry of the DAS, one or more potential threats to safe operation of the vehicle, based at least in part on a plurality of received stimuli; and responding, by the DAS, with second circuitry of DAS, differ and coupled with the first circuitry, to the perceived one or more potential threats, including determining fear levels for the perceived one or more potential threats, based at least in part on a current context of the vehicle, and generating one or more commands to maintain safe operation of the vehicle, based at least in part on the determined fear levels for the perceived one or more potential threats.

Example 21 is example 20, further comprising accepting, by the DAS, with third circuitry, differ and coupled with the second circuitry, information sharing from first one or more other proximally located vehicles on fear determined for the first one or more potential threats, by the one or more other proximally located vehicles; learning, by the DAS, with the third circuitry, operational experiences of second one or more proximally located vehicles from observations of the second one or more other proximally located vehicles; and learning, by the DAS, with the third circuitry, about environmental conditions of an area currently immediately surrounding the vehicle; wherein interpreting with the second circuitry further includes determining, with the second circuitry, the current context, based at least in part on the information sharing accepted, the operational experiences learned, and the environmental conditions learned.

Example 22 is example 21, further comprising outputting, by the DAS, with fourth circuitry, differ and coupled with the second circuitry, notifications of the fear levels determined for a driver of the vehicle.

Example 23 is at least one computer-readable medium (CRM) having instructions stored therein, to cause a driver assistance system (DAS) of a vehicle, in response to execution of the instruction by the DAS, to: accept information sharing from first one or more other proximally located vehicles on fear determined for first one or more potential threats to safe operation of vehicles, by the one or more proximally located vehicles; learn operational experiences of second one or more other proximally located vehicles from observations of the second one or more other proximally located vehicles; and learn about environmental conditions of an area currently immediately surrounding the vehicle; wherein the information sharing accepted, the operational experiences learned, and the environmental conditions learned are used to determine a current context for determining fear levels of perceived potential threats to safe operation of the vehicle.

Example 24 is example 23, wherein the DAS is further caused to determine the current context using the information sharing accepted, the operational experiences learned, and the environmental conditions learned.

Example 25 is example 23, wherein the DAS is further caused to perceive the potential threats to safe operation of the vehicle, based on a plurality of stimuli; and to interpret the perceived one or more potential threats, including to determine fear levels for the perceived one or more potential threats, based at least in part on the determined current context of the vehicle, and to generate one or more commands to maintain safe operation of the vehicle, based at least in part on the determined fear levels for the perceived one or more potential threats.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A computer-assisted or autonomous driving (CAD) system of a vehicle, comprising:
at least one sensor to collect sensor data; and
processing circuitry configured to:
process the sensor data to identify at least one potential threat to safe operation of the vehicle during movement of the vehicle, wherein the at least one potential threat is identified on a path that the vehicle is to travel;
evaluate a heat map, wherein the heat map is based on observations and actions of other vehicles on the path that the vehicle is to travel, and wherein the heat map depicts varying amounts of risk encountered on the path by the other vehicles based on the at least one potential threat;
determine at least one safety action to perform with the CAD system, based on the at least one potential threat identified from the sensor data and the varying amounts of risk depicted in the heat map; and
generate commands to cause the vehicle to implement the at least one safety action with the CAD system, to respond to the at least one potential threat.

2. The CAD system of claim 1, wherein the at least one safety action is determined based at least in part on:
an evaluation of whether the actions of the other vehicles are applicable to the at least one potential threat;
an evaluation of whether the vehicle includes capabilities to avoid or mitigate the at least one potential threat using the actions of the other vehicles taken in response to the at least one potential threat; and
an evaluation of a determined level of threat from the at least one potential threat.

3. The CAD system of claim 1, wherein the processing circuitry is further configured to identify a current context of the vehicle, and wherein the commands to respond to the at least one potential threat are based on the current context of the vehicle.

4. The CAD system of claim 3, wherein the processing circuitry is further configured to learn operational experiences of the other vehicles, and to identify the current context based on the operational experiences.

5. The CAD system of claim 3, wherein the processing circuitry is further configured to obtain data associated with observed errors of the other vehicles, process the data associated with the observed errors of the other vehicles to learn about environmental conditions in an immediate surrounding area of the vehicle, and identify the current context based on the environmental conditions.

6. The CAD system of claim 1, wherein the processing circuitry is further configured to evaluate at least one message that identifies a potential threat to safe operation of the other vehicles, and wherein the heat map is created based on the at least one message.

7. The CAD system of claim 6, wherein the at least one message identifies at least one of adverse weather impact, road hazards, speed bumps, or steep terrain encountered by the other vehicles.

8. The CAD system of claim 1, wherein the at least one safety action includes output of an indicator of a level of threat to the safe operation of the vehicle, wherein the indicator comprises one or more of an audio alert, a visual alert, or a mechanical alert, and wherein the indicator is output to an operator of the vehicle and identifies the level of threat on a spectrum of levels.

9. The CAD system of claim 1, wherein the processing circuitry is further configured to identify a level of threat from the at least one potential threat to safe operation of the vehicle, and the level of threat is based on a risk of the vehicle being operated into a potential emergency situation.

10. The CAD system of claim 1, wherein the at least one safety action to respond to the at least one potential threat includes providing a stimulus to a human driver of the vehicle to pay extra attention.

11. At least one non-transitory computer-readable medium comprising instructions, wherein execution of the instructions by one or more processors is to cause a computer-assisted or autonomous driving (CAD) system of a vehicle to:
process sensor data of the CAD system to identify at least one potential threat to safe operation of the vehicle during movement of the vehicle, wherein the at least one potential threat is identified on a path that the vehicle is to travel;
evaluate a heat map, wherein the heat map is based on observations and actions of other vehicles on the path that the vehicle is to travel, and wherein the heat map depicts varying amounts of risk encountered on the path by the other vehicles based on the at least one potential threat;
determine at least one safety action to perform with the CAD system, based on the at least one potential threat identified from the sensor data and the varying amounts of risk depicted in the heat map; and
generate commands to cause the vehicle to implement the at least one safety action with the CAD system, to respond to the at least one potential threat.

12. The non-transitory computer-readable medium of claim 11, wherein the at least one safety action is determined based at least in part on:
an evaluation of whether the actions of the other vehicles are applicable to the at least one potential threat;
an evaluation of whether the vehicle includes capabilities to avoid or mitigate the at least one potential threat using the actions of the other vehicles taken in response to the at least one potential threat; and
an evaluation of a determined level of threat from the at least one potential threat.

13. The non-transitory computer-readable medium of claim 11, wherein the one or more processors are to execute the instructions to identify a current context of the vehicle, and the commands to respond to the at least one potential threat are based on the current context of the vehicle.

14. The non-transitory computer-readable medium of claim 13, wherein the instructions cause the CAD system to learn operational experiences of the other vehicles, and to identify the current context based on the operational experiences.

15. The non-transitory computer-readable medium of claim 13, wherein the instructions cause the CAD system to obtain data associated with observed errors of the other vehicles, process the data associated with the observed errors of the other vehicles to learn about environmental conditions in an immediate surrounding area of the vehicle, and identify the current context based on the environmental conditions.

16. The non-transitory computer-readable medium of claim 11, wherein the instructions cause the CAD system to evaluate at least one message that identifies a potential threat to safe operation of the other vehicles, and wherein the heat map is created based on the at least one message.

17. The non-transitory computer-readable medium of claim 16, wherein the at least one message identifies at least one of adverse weather impact, road hazards, speed bumps, or steep terrain encountered by the other vehicles.

18. The non-transitory computer-readable medium of claim 11, wherein the at least one safety action includes output of an indicator of a level of threat to the safe operation of the vehicle, wherein the indicator comprises one or more of an audio alert, a visual alert, or a mechanical alert, and wherein the indicator is output to an operator of the vehicle and identifies the level of threat on a spectrum of levels.

19. The non-transitory computer-readable medium of claim 11, wherein the instructions cause the CAD system to identify a level of threat from the at least one potential threat to safe operation of the vehicle, and the level of threat is based on a risk of the vehicle being operated into a potential emergency situation.

20. The non-transitory computer-readable medium of claim 11, wherein the at least one safety action to respond to the at least one potential threat includes providing a stimulus to a human driver of the vehicle to pay extra attention.
